(19) United States
(12) Patent Application Publication
(10) Pub. No.: US 2008/0016789 A1
(43) Pub. Date: Jan. 24, 2008

(54) SPHERICAL HUB FOR MODULAR STRUCTURE SYSTEM

(76) Inventor: Alfred H. Boots, Oak Park, IL (US)

Correspondence Address: BELL, BOYD & LLOYD, LLP, P.O. Box 1135, CHICAGO, IL, 60690, US

(21) Appl. No.: 11/458,321

(22) Filed: Jul. 18, 2006

(51) Int. Cl. E04B 7/08; F16D 1/00

(52) U.S. Cl. 52/81.3; 403/171

(57) ABSTRACT

A modular structure system component includes a body having a substantially spherical core that includes an outer surface. The component further includes a plurality of nodes that each of the plurality of nodes has a first end disposed adjacent to the outer surface and a second end distal to the outer surface and a receiving means provided within each of the plurality of nodes, wherein each of the receiving means is configured to removably cooperate with a corresponding coupler. The body is configured to cooperate with a plurality of structural members that each include one or more of the couplers, and wherein the body and the structural members define a modular structure.

### CROSS REFERENCE TO RELATED APPLICATIONS

This patent is related to U.S. Pat. No. 6,722,086, titled “Modular Structure System”; and U.S. Pat. No. 6,854,238, titled “Structural Connection System for Frameworks”, both patents to Alfred H. Boots, the inventor of the subject mattered disclosed and claimed herein. The entire contents of these patents are incorporated herein by reference for all purposes.

### BACKGROUND

This patent generally relates modular structural systems, and more particularly to spherical hubs or connectors used in conjunction with modular structural system.

Known modular structures generally include frame components or members configured for rapid assembly and disassembly. The frame members are required to (a) provide a durable and stable structure, and (b) be easy to handle and be installable by limited number of persons. The frame members can form a wide variety of shelter frames such as outdoor tents, circus tents, playground equipment, geodesic domes, greenhouses, swimming pool structures, etc. The frame members can also form internal structures, such as furniture, stands, shelving, etc.

Many known modular structural systems utilize and require telescoping members to assemble and disassemble a structure. These telescoping members are costly, complicated manufacture and tend to make the structure less rigid or strong. Some of those systems require inner and outer spring loaded tubes and a bolt or clamp that tightens the members together to form a member having a desired length. Other systems require an internal threaded rod or ball screw that cooperates with an internally threaded member. In operation, when the threaded member is turned relative to the rod or ball screw, the overall length of the member shortens or lengthens. Still other systems require a plurality of internal rods having threaded ends connected by a right angle gear and a second mating gear that couples to a handle, which extends outside of the member to enable an operator to turn the handle and thereby turn the rods to lengthen or shorten the member.

One known structural system disclosed in the above-identified U.S. Pat. No. 6,722,086 provides a modular system for constructing a tubular structure. The disclosed modular system provides for tubular structures to be assembled and disassembled in a direction perpendicular to a centerline of the tubing without having to move the tubing along its centerline. The modular system further allows the tubing to be positioned at various angles and allows curved tubing to be used. In an embodiment, the modular system includes a cylindrical hub and a connector that removably couples to the cylindrical hub. The connector has a first end that couples to the hub and a second that defines a notch. One of the walls of the notch connects to a flange that may extend in one or two directions from the centerline of the connector. The connector and flange removably couple to one end of an adapter, which contains a mating notch, wherein the adapter receives a tube.

Another known structural system disclosed in the above-identified U.S. Pat. No. 6,854,238 provides a modular frameworking system having various apparatuses and methods of attaching same. The disclosed framework includes a plurality of hubs which each include a plurality of pairs of opposing flat faces. Each face connects, in turn, to at least one connector. The disclosed frameworking system includes primary “T” shaped connectors that attach directly to the hubs and secondary “L” shaped connectors that attach to the primary connectors and thus the hub. An adapter is provided and connects at one end to a leg of the connector and at the other end to a structural member, e.g., a straight or curved tube, angle or channel. The adapter and structural member are readily removable from the hub and the connector. The connector can be curved and alternatively includes a hinge so that the connector can rotate. The connectors can attach to each face of the hub and can be rotated in multiple directions on any given face of the hub.

While each of these structural systems provides apparatuses and methods for assembling and constructing modular frameworks and structures, it would be desirable to provide a hub or core design that can further increase the flexibility and utility of these systems. Further, it would be desirable for the flexible hub or core to allow for and cooperate with curved or non-linear members to connect at multiple angles or orientations. Still further, it would be desirable for the flexible hub to be simple and inexpensive to manufacture, thereby reducing the overall cost of the structural system in which it is utilized.

### SUMMARY

The disclosed hub or core includes a substantially spherical body that provides for increased assembly and construction flexibility. The spherical hub can be utilized in cooperation with structural members or tubes to provide a wide variety of modular structures. The spherical hub may be provided with one or more attachment or receiving mechanism disposed, either equidistantly or non-uniformally, around the outer surface of the spherical body. The multiple attachment or receiving mechanisms provide numerous assembly or joining locations which, in turn, offer a great deal flexibility regarding the type of structures that can be assembled.

In an embodiment, a modular structure system component includes a body having a substantially spherical core that includes an outer surface, a plurality of nodes each of which includes a first end disposed adjacent to the outer surface and a second end distal to the outer surface. The substantially spherical core further includes a receiving means provided within each of the plurality of nodes such that each of the receiving means is configured to removably cooperate with a corresponding coupler and wherein the body is configured to cooperate with a plurality of structural members that each include one or more of the couplers, and wherein the body and the structural members define a modular structure.

In another embodiment the substantially spherical core is a substantially solid core.

In another embodiment the plurality of nodes are protuberances configured to extend away from the outer surface.

In another embodiment the receiving means extends through the substantially spherical core between a first node and a second node.

In another embodiment the plurality of nodes are disposed substantially equidistantly about the outer surface of the substantially spherical core.

In another embodiment the substantially spherical core is manufactured from a material selected from the group comprising: aluminum; steel; high density plastic; and wood.

In another embodiment the nodes extend into the substantially spherical core.

In another embodiment a modular structural hub includes a substantially spherical body having an outer surface, a plurality of nodes that each has a first end disposed adjacent to the outer surface of the substantially spherical body and a second end distal to the first end, and a receiving mechanism provided within each of the plurality of nodes, wherein each of the receiving mechanisms is configured to removable cooperate with a coupler carried by a structural member.

In another embodiment the substantially spherical body defines a substantially solid core.

In another embodiment the plurality of nodes are disposed equidistantly about the outer surface of the substantially spherical body.

In another embodiment the receiving mechanism extends through the substantially spherical body between a first node and a second node.

In another embodiment the plurality of nodes extend into the substantially spherical body.

The disclosure further provides a method for manufacturing a modular structural hub that includes providing hub body, forming the hub body to define a substantially spherical shape that includes a substantially smooth outer surface, forming a plurality of nodes equidistantly about the substantially smooth outer surface, each of the plurality of nodes having a first end affixed to the substantially smooth outer surface and a second end extending away from the first end, and providing a receiving mechanism within each of the plurality of nodes, the receiving mechanism configured to cooperate with a structural member.

Additional features and advantages of the present invention are described in, and will be apparent from, the following Detailed Description of the Invention and the figures.

### BRIEF DESCRIPTION OF THE FIGURES

FIG. 1 illustrates one embodiment of a modular structure assembled utilizing a plurality of spherical hubs disclosed and taught herein.

FIG. 2 illustrates another embodiment or configuration of a spherical hub.

FIG. 2A illustrates a sectional view of the spherical hub shown in FIG. 2 taken along the section line II-II.

FIG. 3 illustrates another embodiment or configuration of a spherical hub.

FIG. 3A illustrates a sectional view of the spherical hub shown in FIG. 3 taken along the section line III-III.

FIG. 4 illustrates another embodiment or configuration of a spherical hub that includes nodes or protuberances.

### DETAILED DESCRIPTION

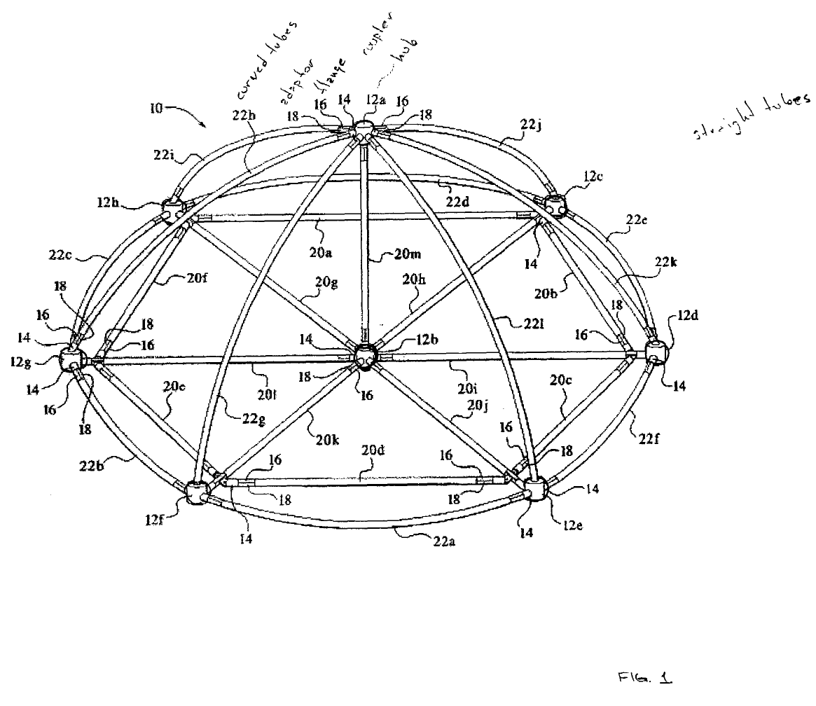

Referring now to the drawings, FIG. 1 illustrates one embodiment of a modular structure 10 assembled in accordance with the disclosure provided herein. The modular structure 10 includes a plurality of spherical hubs or cores 12a to 12h (collectively referred to herein as spherical hubs 12). Each of the spherical hubs 12 is configured to cooperate with one or more connectors or couplers 14. For example, each of the spherical hubs 12 can be configured to removably couple or connect to four, six, eight, ten or more connectors or couplers 14. FIG. 1 illustrates one embodiment of the spherical hubs 12, specifically the spherical hubs identified as 12a and 12b, which are configured to cooperate with seven couplers 14. Alternatively, the spherical hubs 12c to 12h are configured to cooperate with four couplers 14.

Each of the spherical hubs or cores 12 includes one or more receiving mechanisms 30 (see FIGS. 2 to 4) configured to removably cooperate with one or more of the couplers 14. The receiving mechanism 30, or generally the receiving means, may include threaded screw holes, countersunk bores, protruding nodes or locks and any other mechanical connection or locking system that may be integrated into the body of the hub 12. For example, the receiving mechanism 30 could be a threaded screw hole sized to cooperate with a threaded rod portion of the coupler 14 in a male-female mating arrangement. Alternatively, the receiving mechanism 30 could be a twist-lock that includes a receptacle formed within the hub 12 and a finger or tapered finger provided on the coupler 14 and configured to engage or frictionally lock within the receptacle. Regardless of the specific mechanism incorporated into the hub 12 and coupler 14, the receiving means generally provides a locking or securing mechanism to removably connect one or more of the couplers 14 to the central core or hub 12.

Generally, the spherical cores or hubs 12 are physically configured to include receiving mechanisms 30 distributed both latitudinally and longitudinally over the outer surface of the spherical body of the hub 12. For example, the hub 12b of FIG. 1 includes six receiving mechanisms disposed at sixty degree (60°) intervals about the circumference of the body and at least one additional receiving mechanism disposed ninety degrees (90°) away from the circumference of the core. It will be understood that additional receiving mechanisms may be disposed at, for example, forty-five degrees (45°) away from both the circumference and the apex of the core. Moreover, the pattern or distribution of the receiving mechanisms 30 may be defined to allow virtually any desired modular structure 10 to be constructed.

Returning to modular structure 10 illustrated in FIG. 1, the couplers 14 cooperate with, and extend from, the hubs 12 and each include at least one notch or groove. The at least one notch or groove portion of the couplers 14 each attach or cooperate with a flange 16. The flanges 16, in one embodiment, terminate and are flush the couplers 14. In another embodiment, the flanges 16 extend away from one or more surface of the coupler 14 to allow other structural members to connect to, and extend away from, the counterline of the coupler 14, and the hub 12.

The couplers 14 and flanges 16 may, in turn, removable connect to an adaptor 18. The adaptor 18 includes a notch or groove, similar to the notch or groove provided in the coupler 14, configured to cooperate with the flange 16 and the coupler 14. The adaptor 18 may further include a receiving end or opening configured to carry or support one of the straight tubes 20a to 20m (collectively referred to herein as straight tubes 20) or one of the curved tubes 22a to 22l (collectively referred to herein as curved tubes 22). In one embodiment, the end of adaptor 18 is sized to provide an interference fit and/or sliding engagement with an interior portion of a hollow member or tube 20, 22. Alternatively, the adaptor 18 can be configured to cap or otherwise engage and exterior portion of the tubes 20, 22.

The dome shaped modular structure 10 shown in FIG. 1 includes eight hubs or cores 12 connected with a multitude of couplers 14. The couplers 14, in turn, are cooperatively connected to a like number of flanges 16 and adaptors 18. As shown in FIG. 1, the dome shaped structure 10 includes the hub 12a vertically coupled to the hub 12b via the tube 20m. It will be understood that each end of the tubes 20, 22 carries an adaptor 18 configured to cooperate with a coupler 14 and/or a flange 16 to engage one or more of the hubs 12. In this exemplary embodiment, the vertical tube 22m carries a pair of adaptors 18 at either hollow tube end. The adaptors 18, in turn, each cooperate with and removably engage a coupler 14. The entire vertical assembly, which includes the couplers 14, tube 22m and adaptor 18, engages a pair of receiving mechanisms 30 vertically disposed at the base and apex of each of the hubs 12a, 12b, respectively.

The hub 12a further supports six radially disposed receiving mechanisms 30 that cooperate with six coupler 14, flange 16 and adaptor18 components. The hub 12a and six receiving mechanisms 30 connect to six curved tubes 22g, 22h, 22i, 22j, 22k and 22l (collectively referred to herein as domed tubes 22g to 22l) to define the arched or domed portion of the structure 10. Each of the curved tubes 22g to 22l connects and terminates with six corresponding hubs 12c, 12d, 12e, 12f, 12g and 12h (collectively referred to herein as perimeter hubs 12c to 12h). Each of these six hubs 12, in turn, supports at least three radially disposed receiving mechanisms 30. Two of the radially disposed receiving mechanisms 30 cooperate and connect to curved tubes 22a, 22b, 22c, 22d, 22e and 22f (collectively referred to herein as perimeter tubes 22a to 22f) to define the circular perimeter of the domed structure 10.

The third radially disposed receiving mechanism 30 on each of the perimeter hubs 12c to 12h cooperates and connects to straight tubes 20g, 20h, 20i, 20j, 20k and 20l (collectively referred to herein as spoke tubes 20g to 20l). These spoked tubes 20g to 20l radially connect the center or central hub 12b to each of the hubs 12c to 12h positioned along the perimeter of the structure 10. The spoked tubes 20g to 20l are arranged to strengthen and stiffen the perimeter and overall base of the domed structure 10. The perimeter and overall base of the domed structure 10 may be further strengthened by cross-bracing each of the spoked tubes 20g to 20l to one of the adjacent spoked tubes.

The cross-bracing may be accomplished by attaching tubes 20a, 20b, 20c, 20d, 20e and 20f (collectively referred to herein as brace tubes 20a to 20f) to the flange 16 portion disposed adjacent to the perimeter hubs 12c to 12h. In particular, the flange 16 disposed at each perimeters hubs 12c to connects and extends beyond both edges of the corresponding coupler 14 and adaptor 18 to provide a pair of attachment points at each of the perimeter hubs 12c to 12h. These attachment points connect to couplers 14 and adaptors 18 carried at the ends of each of the brace tubes 20a to 20f. In this way, the brace tubs 20a to 20f extend about the base of the structure 10 to strengthen the perimeter tubes 22a to 22f and the spoked tubes 20g to 20l. It will be understood that by altering the number and location of the receiving mechanisms 30 disposed within the hubs 12, any desired shape may be assembled to form the structure 10.

FIGS. 2 and 2A illustrate another embodiment or configuration of a hub 120. FIG. 2 is a plan view of the spherical body portion 122 of the hub 120. The spherical body 122 includes eight receiving mechanisms 30 radially disposed at forty-five degree (45°) intervals about the body circumference. The spherical body further includes a receiving mechanism 30 (hereinafter, for the sake of clarity, identified as the receiving mechanism 30a) disposed orthogonal, i.e., ninety degrees (90°) away from the circumference. A second receiving mechanism (not shown) may be disposed opposite from the receiving mechanism 30a, e.g., the second receiving mechanism is oriented ninety degrees (90°) from the circumference of the spherical body 122 and one hundred-eighty degrees (180°) from the receiving mechanism 30a. This exemplary configuration could allow the hub 120 to function as the corners or apexes of a regular or rectangular modular structure 10. It will be understood that by changing, i.e., increasing or decreasing, the number of receiving mechanisms 30 and altering their relative positions/orientations, different shaped modular structures 10 may be assembled.

FIG. 2A is a sectional view of the hub 120 taken through the spherical body 122 along the section line II-II. The section line II-II bisects the spherical body 122 along the body's circumference and exposes the eight receiving mechanisms 30 formed therein. Each of the receiving mechanisms 30, in this exemplary embodiment, includes a threaded or tapped portion 124 formed within a counterbored portion 126. Both the threaded portion 124 and the counterbored portion 126 are configured to carry and support a coupler 14 (shown as a hidden object in FIG. 2). In this configuration, the coupler 14 may include a cylindrical portion (not shown) sized to slideably engage the interior of the counterbored portion 126. The slideable engagement of these two components provides addition structural support and stability to the resulting modular structure 10. The coupler 14 may integrally include a threaded stud (not shown) sized to engage the threaded portion 124. Alternative, the coupler 14 could include a drilled and countersunk passage or hole to allow a threaded fastener, e.g., a screw or bolt, to removably engage the threaded portion 126.

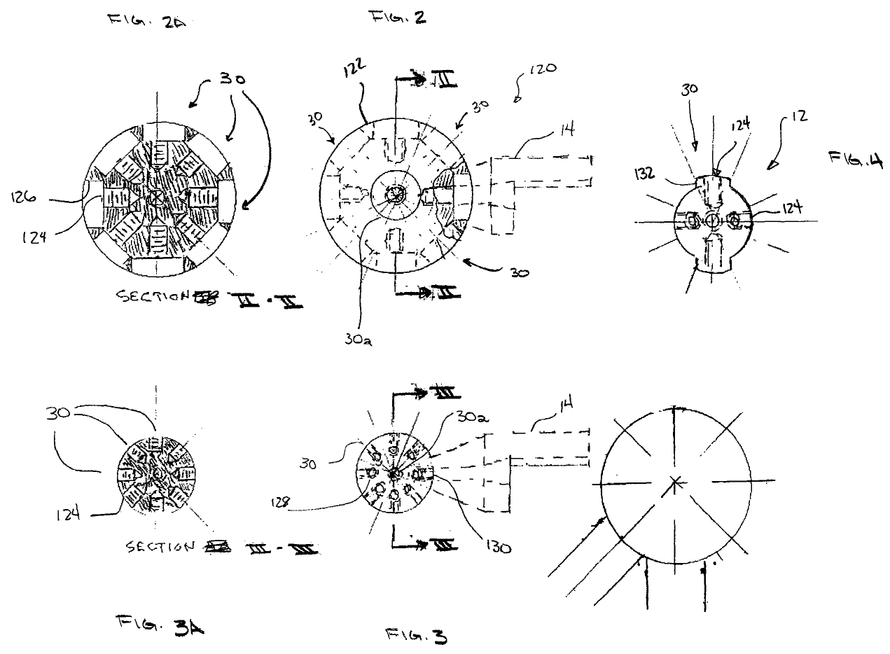

FIGS. 3 and 3A illustrate another embodiment or configuration of a hub 120. FIG. 3 is a plan view illustrating that the spherical body portion 122 includes eight receiving mechanisms 30 radially disposed at forty-five degree (45°) intervals about the body circumference and an additional receiving mechanism 30a disposed orthogonal thereto. In addition to this distribution of receiving mechanisms, which was described in detail in connection with FIG. 2, this spherical body 122 includes a second array 128 of receiving mechanisms 30. In particular, the second array 128 is disposed forty-five degrees (45°) away from both the circumference and the apex of the spherical body 122. In other words, the second array 128 of receiving mechanisms 30 is arranged and oriented between the eight receiving mechanisms 30 at the circumference and the receiving mechanism 30a orthongonal thereto. The illustrated second array 128 includes eight receiving mechanisms, however it will be understood that by increasing or decreasing that number, the location of the receiving mechanisms 30 may be staggered relative to each other.

FIG. 3A is a sectional view of the hub 120 taken through the spherical body 122 along the section line III-III. In this exemplary embodiment, the receiving mechanisms 30 include threaded portions 124. As discussed above, these threaded portions 124 provide a mechanism for removeably engaging the coupler 14 with the hub 120. The absence of counterbored portions 126 allow the overall size of the spherical body to be reduced and may require a concave portion 130, see FIG. 3, be provided on the coupler 14 to allow for a contiguous transition between the two components when assembled. It will be understood, that the overall size of the spherical body 122 may be increased to provide additional surface area and material in which additional receiving mechanisms 30 may be formed. Alternatively, or in addition to, the material of the spherical body 122 may be selected to provide desirable structural strength or component integrity. For example, a spherical body 122 manufactured from tool steel may structurally support more receiving mechanisms 30 than a similar body manufacture from wood or plastic because less steel material is required to resist the stresses likely to be subjected to the assembled modular structure 10 thereby allowing more receiving mechanisms 30 to be formed in a given body 122.

FIG. 4 is a plan view illustrating an embodiment of the spherical body portion 122 wherein the receiving mechanisms 30 include a raised protuberance or node 132. In particular, the raised node 132 extends away from the surface the of spherical body 122. The raised node 132, in this embodiment, supports the threaded portion 124. It will be understood, that a coupler 14 configured to cooperate with the node 132 will typically include a counterbored portion to engage an outer portion or surface of the node 132. Alternatively, the outer surface of the node 132 may be threaded and configured to engage a similarly threaded portion of a coupler 14. In yet another alternative, the threaded portion 132 may extend through the spherical body 122 and/or a pair of aligned nodes 132. These components may be manufactures using any know procedure or equipment, such as, for example drop forging or production on a three axis screw machine.

It should be understood that various changes and modifications to the presently preferred embodiments described herein will be apparent to those skilled in the art. Such changes and modifications can be made without departing from the teachings of the present invention and without diminishing its intended advantages. It is therefore intended that such changes and modifications be covered by the appended claims.

What is claimed is:

1. A modular structure system component comprising:
a body, the body including:
a substantially spherical core, the substantially spherical core having an outer surface;
a plurality of nodes, each of the plurality of nodes having a first end disposed adjacent to the outer surface and a second end distal to the outer surface; and
a receiving means configured to cooperate with each of the plurality of nodes, wherein each of the receiving means is configured to removably engage with a corresponding coupler;
wherein the body is configured to cooperate with a plurality of structural members each including one or more of the couplers, and wherein the body and the structural members define a modular structure.

2. The component of claim 1, wherein the substantially spherical core is a substantially solid core.

3. The component of claim 1, wherein the plurality of nodes are protuberances configured to extend away from the outer surface.

4. The component of claim 1, wherein the receiving means extends through the substantially spherical core between a first node and a second node.

5. The component of claim 1, wherein the plurality of nodes are disposed substantially equidistantly about the outer surface of the substantially spherical core.

6. The component of claim 1, wherein the substantially spherical core is manufactured from a material selected from the group comprising: aluminum; steel; high density plastic; and wood.

7. The component of claim 1, wherein the nodes extend into the substantially spherical core.

8. A modular structural hub, the hub comprising:
a substantially spherical body having an outer surface;
a plurality of nodes, each of the plurality of nodes having a first end disposed adjacent to the outer surface of the substantially spherical body and a second end distal to the first end; and
a receiving mechanism provided within each of the plurality of nodes, wherein each of the receiving mechanisms is configured to removably cooperate with a coupler carried by a structural member.

9. The hub of claim 8, wherein the substantially spherical body defines a substantially solid core.

10. The hub of claim 8, wherein the plurality of nodes are disposed equidistantly about the outer surface of the substantially spherical body.

11. The hub of claim 8, wherein the receiving mechanism extends through the substantially spherical body between a first node and a second node.

12. The hub of claim 8, wherein the plurality of nodes extend into the substantially spherical body.

13. A method for manufacturing a modular structural hub, the method comprising:
providing hub body;
forming the hub body to define a substantially spherical shape that includes a substantially smooth outer surface;
forming a plurality of nodes equidistantly about the substantially smooth outer surface, each of the plurality of nodes having a first end affixed to the substantially smooth outer surface and a second end extending away from the first end; and
providing a receiving mechanism within each of the plurality of nodes, the receiving mechanism configured to cooperate with a structural member.

14. The method of claim 13, wherein the receiving mechanism is formed to extend through the hub body between a first node and a second node.
